(19) United States
(12) Patent Application Publication
(10) Pub. No.: US 2022/0378162 A1
(43) Pub. Date: Dec. 1, 2022

(54) LUGGAGE ITEM SENSOR-BASED DETECTION OF DEVIATION FROM TRAVEL SEQUENCE

(71) Applicant: AT&T Intellectual Property I, L.P., Atlanta, GA (US)

(72) Inventors: Robert T. Moton, Jr., Alpharetta, GA (US); Adrianne Binh Luu, Atlanta, GA (US); James Pratt, Round Rock, TX (US); Barrett Kreiner, Woodstock, GA (US); Walter Cooper Chastain, Atlanta, GA (US); Ari Craine, Marietta, GA (US); Robert Koch, Peachtree Corners, GA (US)

(21) Appl. No.: 17/330,743

(22) Filed: May 26, 2021

(51) Int. Cl. A45C 13/24; H04W 4/029; H04W 4/02; H04W 4/38; H04W 4/12; G06N 3/02

(52) U.S. Cl. CPC A45C 13/24; H04W 4/029; H04W 4/025; H04W 4/38; H04W 4/12; G06N 3/02

(57) ABSTRACT

A processing system including at least one processor may obtain at least one input indicating an expected travel sequence associated with the luggage item. The processing system may then obtain a set of sensor inputs for the luggage item, obtain location information of a user associated with the luggage item, and apply the set of sensor inputs and the location information of the user to at least one machine learning model, where the at least one machine learning model is to detect a deviation from the expected travel sequence. The processing system may next determine, via an output of the at least one machine learning model, that a deviation from the expected travel sequence has occurred, and provide an alert via at least one of an output component of the luggage item or a computing device of the user.

The present disclosure relates generally to baggage handling systems, and more particularly to methods, computer-readable media, and apparatuses for providing an alert in response to detecting a deviation from an expected travel sequence of a luggage item via a machine learning algorithm.

### BACKGROUND

Current trends in wireless technology are leading towards a future where virtually any object can be network enabled and Internet Protocol (IP) addressable. The pervasive presence of wireless networks, including cellular, Wi-Fi, ZigBee, satellite and Bluetooth networks, and the migration to a 128-bit IPv6-based address space provides the tools and resources for the paradigm of the Internet of Things (IoT) to become a reality. In addition, “smart luggage” is increasingly becoming prevalent. So called “smart luggage” may provide battery power to charge and run mobile computing devices, and may include opening detection and local proximity sensing.

### SUMMARY

In one example, the present disclosure describes a method, computer-readable medium, and apparatus for providing an alert in response to detecting a deviation from an expected travel sequence of a luggage item via a machine learning algorithm. For instance, in one example, a processing system including at least one processor may obtain at least one input indicating an expected travel sequence associated with the luggage item. The processing system may then obtain a set of sensor inputs for the luggage item, obtain location information of a user associated with the luggage item, and apply the set of sensor inputs and the location information of the user to at least one machine learning model, where the at least one machine learning model is to detect a deviation from the expected travel sequence. The processing system may next determine, via an output of the at least one machine learning model, that a deviation from the expected travel sequence has occurred, and provide an alert via at least one of an output component of the luggage item or a computing device of the user.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates an example travel sequence, in accordance with the present disclosure;

FIG. 3 illustrates an example tag information record and an example tag database, in accordance with the present disclosure;

FIG. 4 illustrates a flowchart of an example method for providing an alert in response to detecting a deviation from an expected travel sequence of a luggage item via a machine learning algorithm; and

FIG. 5 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for providing an alert in response to detecting a deviation from an expected travel sequence of a luggage item via a machine learning algorithm. In particular, examples of the present disclosure include an electronic identification tag of a luggage item for transportation along a route associated with a user who is also engaging in transportation along the route. The electronic identification tag may contain a set of static and dynamic data and network communications capabilities that enable a number of useful functions. In one example, the electronic identification tag may communicate with other people or other items, such as a mobile computing device of the user, other pieces of luggage, checkpoints, and transport vehicles such as planes, trucks, and rental vehicles, and so forth.

In one example, the electronic identification tag may include a display screen, which may be used to display a bar code or other information that may be used for identification or other purposes. The electronic identification tag may also include a tag database which may store data that may be used for various purposes and functions. The electronic identification tag may also include components for communication via one or more modalities, which may include near-field communication (NFC), and wide area network (WAN) communication, such as cellular or non-cellular wireless communications. The electronic identification tag may be implemented as a fixed part of the luggage item, or as a separate item that may be affixed to or contained within the luggage item. The electronic identification tag may be on the exterior of the luggage or it may be within the luggage when it is closed.

The user may activate the electronic identification tag, for example, upon purchase. This may be accomplished, for instance, via a near-field communication, such as an Institute of Electrical and Electronics Engineers (IEEE) 802.15-based communication (e.g., Bluetooth). The user may use a device containing software, such as a wireless application on a user mobile device, to initiate a communication with the electronic identification tag to activate the electronic identification tag for use. In one example, the user may download an application (“app”) to the user's mobile computing device. The user may also download a unique key based on a unique identifier, such as a serial number of the electronic identification tag, which may be exchanged between the app and the electronic identification tag for activation.

The activation may include sending user-identifying data to the electronic identification tag for the electronic identification tag to store in the tag database. For instance, the user may enter a name, an address, and contact information to be stored on the electronic identification tag. The electronic identification tag may be configured to permit activation only via a NFC enhanced security. Alternatively, the activation may be performed via one or more networks such as over the Internet. The electronic identification tag may subsequently use its communication capabilities to access a wide area network via Wi-Fi, Long Term Evolution (LTE), 5E, or others, to create or update an entry in a network-based luggage management database, which may contain tag data for a multiplicity of electronic identification tags for various users.

The electronic identification tag may also contain a unique identifier that may be used to address communications with the electronic identification tag and which may be used as an index to store or retrieve tag data associated with the electronic identification tag in the luggage management database. This may be an Internet Protocol (IP) address or similar identifier. This data may also be sent to and maintained within the luggage management database, e.g., during a registration process.

Over time, the electronic identification tag may detect and update changes to some types of data in the on-board tag database. It may also be in communication with any of the previously noted types of sensors that are also on-board the luggage item via network or NFC capabilities used by the sensors (e.g., including wireless and/or wired communication). The electronic identification tag may also create a time-stamped log to track data changes over time. In this manner, the electronic identification tag may record the time duration of a journey, the location of the electronic identification tag (and hence the location of the luggage item) at points in time, and so forth. The electronic identification tag may also be in communication with a mobile computing device of the user (e.g., a luggage management app thereon) and correlate the location of the electronic identification tag with the location of the user's mobile computing device (and hence the location information of the user) to determine a proximity of the electronic identification tag (and/or the luggage item) to the user. The electronic identification tag may also determine a proximity of the electronic identification tag to an expected location and send an alert to the user (e.g., via the app, short message service (SMS)/text message, or other communications to the user's mobile computing device) if the electronic identification tag is out of range of its expected location at a point in time. For instance, if the user is waiting to retrieve the luggage item at an airport baggage claim and the electronic identification tag (and luggage item) is still on the plane, the electronic identification tag can alert the user, e.g., via the app or other electronic communications. Similarly, if the electronic identification tag detects that the luggage item is moving away from a baggage claim area, the alert may indicate that another person may have possession of the bag.

The electronic identification tag may also interact with other elements of the environment, which may be in the context of various legs of a journey. For instance, the electronic identification tag may communicate with content items placed into the luggage item. For example, these content item may also contain electronic identifiers (e.g., radio frequency identification (RFID) tags) that may be sensed by the electronic identification tag and recorded on the electronic identification tag as included content items contained within the luggage item. Identification of content items may also be obtained for content items not containing electronic identifiers, such as via bar codes, or using visual recognition techniques based on images obtained via a camera (e.g., on-board the luggage item or external, such as a camera of the user's mobile computing device). With the contents of the luggage item known and stored, when the user is not in possession of the luggage item, the user may query the electronic identification tag or the luggage management database for the contents. For instance, if the user does not recall if a particular content item is packed, for evidence for an insurance claim if the luggage item is lost, and so forth.

In one example, the electronic identification tag may communicate with a security checkpoint to facilitate screening, for instance, at an airport. To illustrate, the electronic identification tag may communicate the contents of the luggage item with the security checkpoint, which may compare the stored inventory against an image of the contents obtained via a scanner of the security checkpoint. An alert may be provided to the security checkpoint, the user, or both if there are any differences. Alternatively, the electronic identification tag may also determine a safety compliance level based on the contents packed in the bag once the bag is closed, e.g., when the user has finished packing at home. Subsequently, the electronic identification tag may self-detect if the luggage item is opened, e.g., if a latch is detected to be opened. If the latch is opened after packing is complete, a potential breach may be recorded on the electronic identification tag and the electronic identification tag may communicate this to the security checkpoint to alert for additional screening.

The electronic identification tag may communicate with various carriers that transport the luggage item during a journey. When a new leg of a journey begins, for instance when the luggage item is placed in a rideshare vehicle, the electronic identification tag may detect the luggage item's presence in the vehicle, for instance, by having the electronic luggage tag app communicate with a rideshare app on the user's mobile computing device. The electronic identification tag may then begin to log the handling of the luggage item during the leg of the journey within the rideshare vehicle. For instance, sensors in the luggage item may report handling, timeliness of arrival, and environmental conditions. The results may also be reported to the rideshare carrier at the end of the leg of the journey. In this way, the electronic identification tag may be recognized as an entity providing a “review” of the leg of the journey. In addition, this data may be combined with similar reviews of other electronic identification tags of other luggage items to create aggregate ratings of carriers and drivers, pilots, handlers, and others.

In a similar manner, the electronic identification tag may be used to store data related to a service-level agreement (SLA) that the user either has established through prior arrangement or payment with a carrier or may be used to negotiate an SLA with a carrier on-the-spot. For instance, the luggage item may contain fragile contents and require delicate handling. The user may accordingly designate an SLA with a carrier, for instance an airline, to indicate that delicate handling should be applied to the luggage item. The electronic identification tag may broadcast this SLA to any equipment or personnel of the carrier along the travel path via near-field or other communication means so that appropriate handling may be applied. For instance, a baggage handler may wear augmented reality (AR) glasses and see an AR “FRAGILE” display, or the electronic identification tag may comprise or be in communication with a display screen of the luggage item to present the same or similar information.

Over time, a luggage item (or the electronic identification tag) may establish a travel history. It may record destinations that it has been to, a number of miles and trips with a particular carrier, a number of miles and trips using a rideshare service or a rental vehicle service, and so forth. The luggage item (or the electronic identification tag) may also establish a level of “intelligence” that may be determined based on a number of successful interactions with other devices and people over time, and/or other factors. The travel history and intelligence level may be used by carriers to grant privileges during travel, such as expedited security screening, or may be used likewise to flag a luggage item that is considered to have a higher probability for creating a problem.

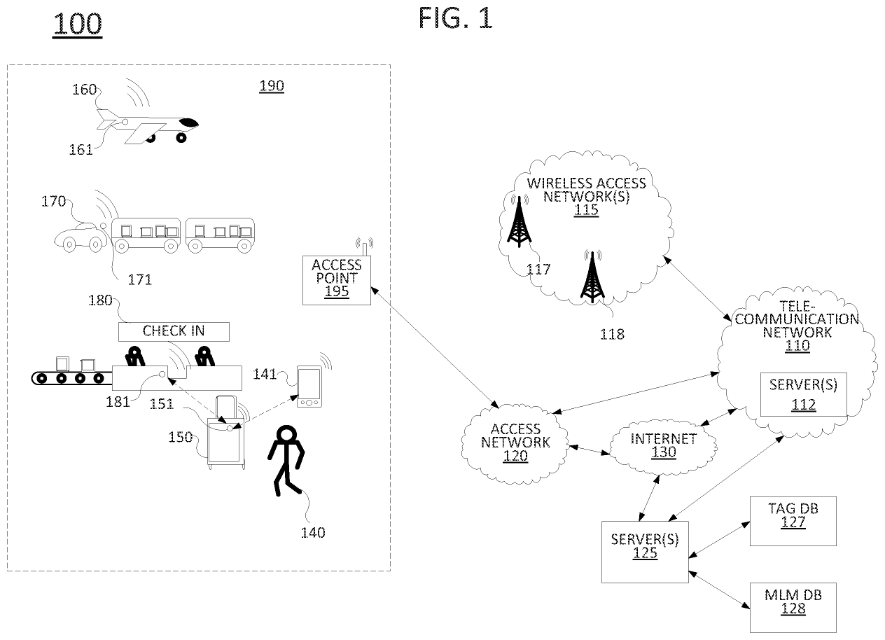

An electronic identification tag may be in communication with other electronic identification tags that it is associated with, for instance, all luggage items of a family traveling together. In this case the luggage items and their associated electronic identification tags may be set up as members of a pod. All electronic identification tags within a pod may have the same unique pod ID, which may be established using the wireless app when the user (e.g., one of the family members) is packing for the trip. One of the electronic identification tags may be designated as a pod leader tag during the setup. The pod leader tag may query the other electronic identification tags and track, manage, and report status of the pod as a whole. The pod leader tag may ensure that the pod of luggage items stays together in proximity and may send an alert, or alerts if any members of the pod stray away. If other electronic identification tags within the pod detect an absence or unexpected location of the pod leader tag, the remaining members of the pod may note that the pod leader tag is away and elect a new pod leader tag. This “election” may be based on factors such as each luggage item's and/or each electronic identification tag's travel history or owner. For instance, in the case of a family of two parents and a child traveling together, if one parent's bag is lost, the other parent's bag can take over as pod leader tag. In another example, a bag with the highest intelligence level may be selected as the new pod leader tag, and so forth. These and other aspects of the present disclosure are discussed in greater detail below in connection with the examples of FIGS. 1-5.

To aid in understanding the present disclosure, FIG. 1 illustrates an example system 100, related to the present disclosure. As shown in FIG. 1, the system 100 connects user device 141, server(s) 112, server(s) 125, access point 195, electronic identification tag 151, and so forth with one another and with various other devices via a core network, e.g., a telecommunication network 110, a wireless access network 115 (e.g., a cellular network), and Internet 130. In one example, additional devices, such as nodes 161, 171, and/or 181 may also be equipped for wired and/or wireless-based network communications (or wired communications) and may be connected with various other devices, via the system 100, such as access point 195, servers, 122, electronic identification tag 151, user device 141, and so forth.

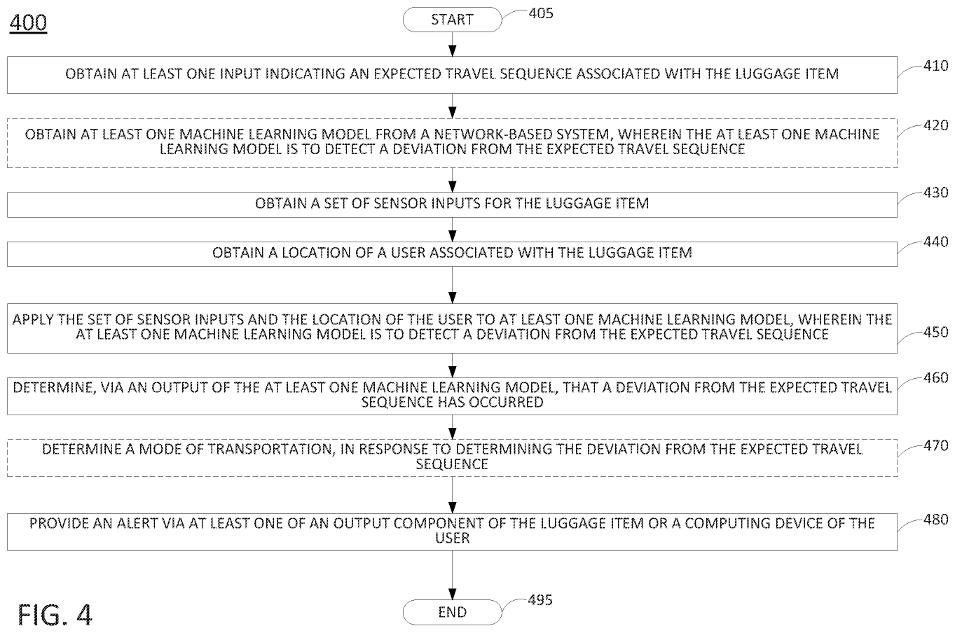

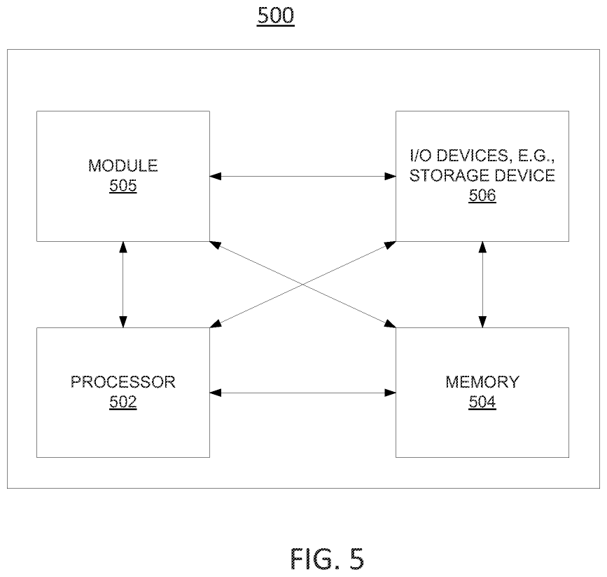

In one example, the server(s) 125 may each comprise a computing device or processing system, such as computing system 500 depicted in FIG. 5, and may be configured to perform one or more steps, functions, or operations in connection with examples of the present disclosure for providing an alert in response to detecting a deviation from an expected travel sequence of a luggage item via a machine learning algorithm. For instance, an example method for providing an alert in response to detecting a deviation from an expected travel sequence of a luggage item via a machine learning algorithm is illustrated in FIG. 4 and described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 5 and discussed below) or multiple computing devices collectively configured to perform various steps, functions, and/or operations in accordance with the present disclosure.

In one example, server(s) 125 may comprise, or be coupled to or in communication with a tag database (DB) 127 and a machine learning model (MLM) database (DB) 128. For instance, the server(s) 112, or server(s) 125 in conjunction with tag database 127 and MLM database 128 may comprise a luggage management system in accordance with the present disclosure. In one example, tag database 127 and MLM database 128 may represent one or more distributed file systems, e.g., a Hadoop® Distributed File System (HDFS™), or the like. Server(s) 125 may receive and store information regarding luggage items, electronic identification tags, and users/user devices associated with such electronic identification tags in tag database 127.

In one example, the system 100 includes a telecommunication network 110. In one example, telecommunication network 110 may comprise a core network, a backbone network or transport network, such as an Internet Protocol (IP)/multi-protocol label switching (MPLS) network, where label switched routes (LSRs) can be assigned for routing Transmission Control Protocol (TCP)/IP packets, User Datagram Protocol (UDP)/IP packets, and other types of protocol data units (PDUs), and so forth. It should be noted that an IP network is broadly defined as a network that uses Internet Protocol to exchange data packets. However, it will be appreciated that the present disclosure is equally applicable to other types of data units and transport protocols, such as Frame Relay, and Asynchronous Transfer Mode (ATM). In one example, the telecommunication network 110 uses a network function virtualization infrastructure (NFVI), e.g., host devices or servers that are available as host devices to host virtual machines comprising virtual network functions (VNFs). In other words, at least a portion of the telecommunication network 110 may incorporate software-defined network (SDN) components.

As shown in FIG. 1, telecommunication network 110 may also include one or more servers 112. In one example, each of the server(s) 112 may comprise a computing device or processing system, such as computing system 500 depicted in FIG. 5 and may be configured to provide one or more functions in connection with examples of the present disclosure for providing an alert in response to detecting a deviation from an expected travel sequence of a luggage item via a machine learning algorithm. For example, one or more of the server(s) 112 may be configured to perform one or more steps, functions, or operations in connection with the example method 400 described below. In one example, server(s) 112 may perform the same or similar functions as server(s) 125. For instance, telecommunication network 110 may provide a luggage management system, e.g., as a service to one or more subscribers/customers, in addition to telephony services, data communication services, television services, etc. For ease of illustration, various additional elements of telecommunication network 110 are omitted from FIG. 1.

In one example, one or more wireless access networks 115 may each comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network(s) 115 may each comprise an access network in accordance with any “second generation” (2G), “third generation” (3G), “fourth generation” (4G), Long Term Evolution (LTE), “fifth generation” (5G), or any other existing or yet to be developed future wireless/cellular network technology. While the present disclosure is not limited to any particular type of wireless access network, in the illustrative example, base stations 117 and 118 may each comprise a Node B, evolved Node B (eNodeB), or gNodeB (gNB), or any combination thereof providing a multi-generational/multi-technology-capable base station. In the present example, user device 141, electronic identification tag 151, nodes 161, 171, and/or 181, and so forth may be in communication with base stations 117 and 118, which provide connectivity between user device 141, electronic identification tag 151, nodes 161, 171, and/or 181, and other endpoint devices within the system 100, various network-based devices, such as server(s) 112, server(s) 125, and so forth. In one example, wireless access network(s) 115 may be operated by the same service provider that is operating telecommunication network 110, or one or more other service providers. For instance, telecommunication network 110 may comprise a cellular core network.

As illustrated in FIG. 1, user device 141 may comprise, for example, a cellular telephone, a smartphone, a tablet computing device, a laptop computer, a desktop computer, a wireless enabled wristwatch, or any other wireless and/or cellular-capable mobile telephony and computing devices (broadly, a “mobile device” or “mobile endpoint device”). In one example, user device 141 may be equipped for cellular and non-cellular wireless communication. For instance, user device 141 may include components which support peer-to-peer and/or short range wireless communications, e.g., IEEE 802.11 based communications (e.g., Wi-Fi, Wi-Fi Direct), IEEE 802.15 based communications (e.g., Bluetooth, Bluetooth Low Energy (BLE), and/or ZigBee communications), LTE Direct, Dedicated Short Range Communications (DSRC), e.g., in the 5.9 MHz band, or the like, a 5G device-to-device (D2D) sidelink, such as over a P5 interface, and so forth. For instance, user device 141 may include one or more radio frequency (RF) transceivers, e.g., for cellular communications and/or for non-cellular wireless communications. In one example, user device 141 may comprise a computing device or processing system, such as computing system 500 depicted in FIG. 5, and may be configured to perform one or more steps, functions, or operations for providing an alert in response to detecting a deviation from an expected travel sequence of a luggage item via a machine learning algorithm. For instance, an example method for providing an alert in response to detecting a deviation from an expected travel sequence of a luggage item via a machine learning algorithm is illustrated in FIG. 4 and described below.

Similarly, luggage item 150 may include an electronic identification tag 151, which may include one or more radio frequency (RF) transceivers (as well as antenna(s), and/or other components) for cellular communications and/or for non-cellular wireless communications such as for IEEE 802.11 based communications, IEEE 802.15 based communications, and so forth. In one example, electronic identification tag 151 may also include a module with one or more additional controllable components, such as an altimeter, a global positioning system (GPS) unit, an accelerometer, a gyroscope, a compass, a thermometer, a radiation sensor (e.g., an x-ray sensor), a microphone or acoustic sensor, and so forth. However, for ease of illustration, such components of the electronic identification tag 151 are omitted from FIG. 1. In addition, electronic identification tag 151 may include a data storage unit (e.g., a solid state drive (SDD) and/or a non-volatile memory (NVM), or the like), for storing a tag information record.

In one example, electronic identification tag 151 may comprise a computing device or processing system, such as computing system 500 depicted in FIG. 5, and may be configured to perform one or more steps, functions, or operations for providing an alert in response to detecting a deviation from an expected travel sequence of a luggage item via a machine learning algorithm (such as illustrated in FIG. 4 and described below).

In the present example, access point 195 may be associated with a transit location, e.g., an airport 190. For instance, access point 195 may be a wireless access point of a local network provided by the airport 190. The nodes 161, 171, and 181 may be in communication with access point 195 and may transmit and/or received data from other devices in the system 100 via access point 195 (and/or via access network 120, Internet 130, wireless access network(s) 115, etc.). In one example, nodes 161, 171, and 181 may have cellular or non-cellular wireless communication, or wired network communication capabilities (not shown). In one example, access point 195 may also establish communications with electronic identification tag 151 and/or user device 141 and may provide connectivity for electronic identification tag 151 and/or user device 141 to Internet 130, telecommunication network 110, devices or system accessible via such networks (e.g., server(s) 125, etc.), and so on.

In an illustrative example, a user 140 having user device 141 may be commencing a trip with luggage item 150 accompanying the user 140 on the trip. Luggage item 150 may have electronic identification tag 151 affixed to, contained within, or integrated with (broadly “associated with”) luggage item 150. Prior to leaving for airport 190, the electronic identification tag 151 may be loaded with information regarding a trip itinerary. For instance, the trip itinerary may include an identification of a carrier, a flight number, a departure airport, a destination airport, an expected departure time, an expected arrival time, and so forth. The trip itinerary may further include an indication of whether luggage item 150 is a checked baggage item or a carry-on baggage item. In one example, the user 140 may load the trip itinerary to the electronic identification tag 151, e.g., via a luggage management app on the user device 141. The user device 141 and electronic identification tag 151 may be in local communication (e.g., via near-field wireless communication, via universal serial bus (USB) pairing, etc.). In another example, the user device 141 and electronic identification tag 151 may be in communication via one or more networks. In one example, such a network-based communication may be managed through a luggage management system (e.g., servers 125, or the like). In another example, the user 140 may permit a travel-related system to communicate with the electronic identification tag 151 to provide the itinerary. For instance, the user 140 may provide an identifier of the electronic identification tag 151 to an automated online system of the airline, which may then transmit the itinerary to the electronic identification tag 151, e.g., in designated or expected format, such as via an Extensible Markup Language (XML) schema, a Java Script Object Notation (JSON) object, or the like. Although an itinerary may include multiple legs of an overall journey in accordance with the present disclosure, for illustrative purposes it may be assumed that the user 140 is engaging in just an air travel component in connection with the example of FIG. 1.

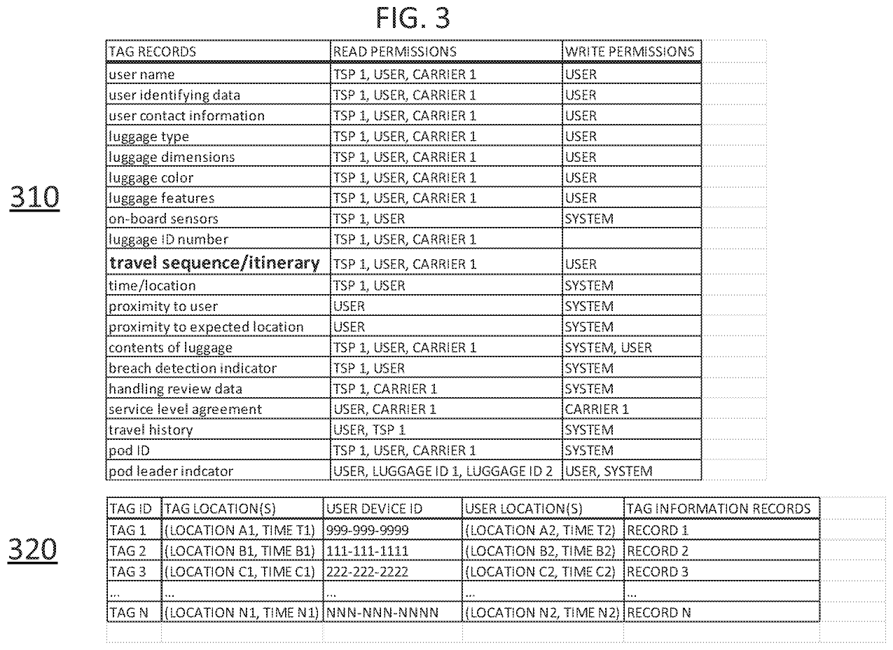

In addition, electronic identification tag 151 may also store various additional information, e.g., in a tag information record. An example tag information record 310 is illustrated in FIG. 3. For instance, tag information record 310 may represent information stored by electronic identification tag 151. To illustrate, tag information record 310 may include: a user name, user identifying data, and user contact information, a luggage type, luggage dimensions, luggage color, and luggage features of a luggage item, available on-board sensors of the luggage item and/or the electronic identification tag, a luggage ID number, time stamped location records, records of a proximity of the electronic identification tag to a user, records of a proximity to an expected location, a list of contents of the luggage item, a breach detection indicator (or a timestamp of multiple openings/breach detections), handling review data, service level agreement (SLA) data, a travel history (e.g., records regarding positive, negative, or neutral interactions with humans or other autonomous systems, or interactions scaled/rated from 0 to 100, 0 to 5 stars, etc., a pod ID, a pod leader indicator, and so forth). In addition to values for each of these data items, a field may also include read and write permissions for the respective data item. For instance, for the user name field, only the user has permission to write/change the value of the field, while the user, carrier 1, and transportation security provider (TSP) 1 (e.g., Transportation Security Administration (TSA) in the United States, or the like), may have permission to read the contents of this field, which may be encrypted. On the other hand, in the present example, only the system itself (the electronic identification tag) can write to the travel history, while only the user and TSP 1 can access/read the travel history. In this case, carrier 1 is not granted a permission to read the travel history. Notably, tag information record 310 includes a field for an expected travel sequence/itinerary, as mentioned above.

It should be noted that the example tag information record 310 is just one example that is possible in accordance with the present disclosure. For instance, in another example, carrier 1 may be granted access to a travel history, or may be granted access to a travel history within a given look-back time period, e.g., only the last 72 hours. Similarly, carrier 1 may be granted access to a breach detection indicator since the user may consent to have carrier 1 be allowed to access such information. For instance, if a breach of a carry-on bag is detected after passing a security checkpoint and before boarding, in the event the user misses a notification of the breach, carrier 1 may still detect the breach and investigate, or alert the user to investigate to determine that there is no security or safety issue. Any number of the fields can also be encrypted for security with predefine encryption protocols and/or encryption keys.

In addition to an itinerary and other fields/data in tag information record 310, electronic identification tag 151 may also store one or more machine learning models (MLMs) associated with an expected travel sequence (e.g., the itinerary or a travel sequence that is based on the itinerary). For instance, electronic identification tag 151 may obtain one or more MLMs from server(s) 125 that are stored in machine learning model (MLM) database (DB) 128. In one example, electronic identification tag 151 may also retrain and update such MLM(s) based upon travel experiences of the electronic identification tag 151, and in one example, in particular connection with the travels of user 140. Accordingly, electronic identification tag 151 may monitor its own location, a location of user 140 and/or user device 141, and other conditions, to detect deviations from an expected travel sequence using these factors as inputs to the one or more MLMs. In other words, the MLMs are trained and configured for detecting deviations from expected travel sequences.

In the example, of FIG. 1, user 140 may approach a check-in counter 180 at airport 190 having a node 180. The check-in process may proceed in a customary manner and may result in loading of luggage item 150 onto a conveyor to be brought to baggage handlers. The luggage item 150 may then be loaded onto a baggage cart 170, which may have a node 171, to be transported and loaded onto aircraft 160 having a node 161. While the luggage item 150 is being transported to and loaded on the aircraft 160 via the baggage handling process, user 140 may complete a check-in process and may proceed through a security checkpoint, wait at a departure gate, and may eventually board the aircraft 160. The aircraft 160 may then push back from the gate, taxi to the end of a runway, takeoff, and fly to the destination. At the destination a similar process may unfold in reverse, culminating in the user 140 retrieving luggage item 150 from a baggage claim area.

Throughout the journey, in one example, electronic identification tag 151 may report its location, e.g., detected via a GPS unit of the electronic identification tag 151, to server(s) 125. For instance, electronic identification tag 151 may report its location to servers(s) 125 via access point 195, base stations 117 and/or 118, and so forth, and over one or more networks such as access network 120, wireless access networks 115, Internet 130, telecommunication network 110, etc. In addition, electronic identification tag 151 may also perform local proximity sensing and/or communication with user device 141 such as via IEEE 802.15 communications, 802.11 communications (e.g., Wi-Fi Direct), etc. In one example, user device 141 may perform the same or similar operations, such as determining its location (e.g., via a GPS unit of the user device 141), reporting the location to server(s) 125, and engaging in local sensing and/or communication with electronic identification tag 151 (e.g., on an ongoing basis throughout the journey, or at least as long as user device 141 is powered-on and/or has an active radio). In one embodiment, electronic identification tag 151 may include an “airplane mode” or “flight mode” that will temporary suspend its long range communication capability, e.g., based on an altitude measurement, or receiving an instruction signal directly from the aircraft itself, e.g., the pilot activating a command signal from the flight deck that will instruct all electronic identification tags 151 onboard the aircraft to suspend its long range communications.

At the airport 190, in one example, nodes 161, 171, and 181 can report locations of luggage items via detection of electronic identification tags (such as electronic identification tag 151). Similarly, nodes 161, 171, and 181 may detect and report locations of users and/or user devices (such as user device 141). For instance, nodes 161, 171, and 181 may report electronic identification tag, user, and/or user device locations to servers(s) 125 via access point 195, base stations 117 and/or 118, wired links of airport network 190 (now shown), and so forth, and over one or more networks such as access network 120, wireless access networks 115, Internet 130, telecommunication network 110, etc. In another example, there may be passive or active radio frequency (RFID) beacons that can be sensed by electronic identification tags (such as electronic identification tag 151) or user devices (such as user device 141). Thus, while electronic identification tag 151 may also record coordinates/geographic location, e.g., via a GPS unit, it may also report that it has passed a milestone/waypoint based upon sensing/scanning nodes 161, 171, and/or 181. For instance, GPS location data that indicates the luggage item 151 is within an airport perimeter is insufficient to indicate that it has been loaded on a plane, or that it is on a particular plane. Similarly, user device 141 may sense/scan node 161, which may more precisely indicate that user 140 has boarded aircraft 160. In one example, user device 141 and electronic identification tag 151 may share such additional location information as it is detected, e.g., via local peer-to-peer wireless communication, such as NFC communication, Wi-Fi Direct, Bluetooth, a 5G sidelink, etc., and to the extent such direct wireless communication is available. This information may also be reported to server(s) 125. In one example, server(s) 125 may also pass such information between user device 141 and electronic identification tag 151 via various networks and components of the system 100 (e.g., in the event that user device 141 and electronic identification tag 151 are not able to establish direct wireless communication and/or a peer-to-peer communication).

In addition to location information, user device 141 and/or electronic identification tag 151 may also exchange additional information with each other and/or report to server(s) 125 (e.g., such information may be obtained via server(s) 125 as an alternative or when user device 141 and/or electronic identification tag 151 are not able to establish a direct wireless communication and/or peer-to-peer communication). For instance, electronic identification tag 151 may detect that luggage item 150 is opened and may report this incident to user device 141 and to server(s) 125. Similarly, user 140 may have a change of plans/change of itinerary and may report this change to electronic identification tag 151 and to server(s) 125 via user device 141. For instance, a seat on a flight to another airport that is closer to the final destination of user 140 may become available after luggage item 150 has passed the check-in counter 180. However, the baggage handling process may be able to divert the luggage item 150 to the new flight and the new destination airport. As such, the change in itinerary may be communicated to electronic identification tag 151, which may then have an awareness of a different expected travel sequence (e.g., a different expected baggage loading time, a different expected departure time, a different expected flight duration, a different expected baggage handling process at the new airport, etc.).

In one example, server(s) 125 may store information received from user devices, electronic identification tags, and/or other devices, such as nodes 161, 171, and 181, in tag database (DB) 127. For instance, an example tag database 320 is illustrated in FIG. 3, which may comprise or represent tag DB 127 in FIG. 1. As shown in FIG. 3, the tag database 320 may include a record for each electronic identification tag, e.g., tag 1, tag 2, tag 3, tag n, etc. In the present example, tag 1 in tag database 320 may be electronic identification tag 151 affixed to, within, or integrated with (broadly “associated with”) luggage item 150. In one example, for each electronic identification tag, the record may include a last location of the electronic identification tag. Alternatively, or in addition, the record may include a set of time-stamped locations of the electronic identification tag, e.g., for the last week, for the last month, for the last 3 months, etc. In one example, each record may also include a user device identifier (ID) associated with a user device of a user associated with the electronic identification tag. For instance, the user device ID may comprise a phone number of the user device (e.g., a mobile phone). Alternatively, or in addition, the user device ID may comprise an international mobile subscriber identity (IMSI) number, an international mobile equipment identifier (IMEI) number, an IP address, and so forth. In addition, each record may include a last location of the user (which may also include a time the last location was recorded), or a series of time-stamped locations of the user. It should be noted that the location(s) of the user may be determined from a location of the user's mobile device, but may alternatively or additionally be determined in other ways.

For instance, in the example of FIG. 1, if user 140 scans a boarding pass at a gate to board airplane 160 and that information is shared by the airline with server(s) 125, the location of user 140 being at the gate and/or on the airplane 160 may be noted in the associated tag record. In this way, the location of user 140 as reported by user device 141 may be further verified, or the location of user 140 may be determined regardless of whether user device 141 is powered on or off, whether the user device 141 has a network connection or not, whether the user device 141 is wirelessly discoverable or not, and so on. Each record may also include a tag information field to store various addition information regarding an electronic identification tag. For instance, the tag information field may comprise the same or similar information as tag information record 310 if FIG. 3 (e.g., all of the data of tag information record 310, at least a portion of the tag information record 310, a portion of the tag information record 310 plus additional information, such as one or more MLMs that are currently in use on an electronic identification tag, and so on). Server(s) 125 may thus access the tag DB 127 to record information therein or to retrieve information to provide to the electronic identification tags or user devices, and in one example, to other authorized stakeholder devices (such as an authorized transportation security provider, an authorized carrier, etc.).

In one example, machine learning model (MLM) database (DB) 128 may store various machine learning models for detecting deviations from expected travel sequences. For instance, a first machine learning model may be for detecting a deviation from an expected flight sequence, a second machine learning model may be for detecting a deviation from an expected departure baggage handling sequence, a third machine learning model may be for detecting a deviation from an expected arrival baggage handling sequence, and so forth. In one example, there may be different machine learning models for different departure baggage handling sequences and/or arrival baggage handling sequences, e.g., for checked luggage items, gate-check luggage items, carry-on luggage items, oversized luggage items, and so on. In one example, a machine learning model may cover several legs of the expected travel sequence, e.g., from gate check-in through aircraft takeoff, from gate check-in through landing at a destination airport, from leaving a point of origin via surface transportation to aircraft takeoff, and so on.

In accordance with the present disclosure, detecting a deviation from an expected travel sequence may be in accordance with one or more machine learning algorithms (MLAs), e.g., one or more trained machine learning models (MLMs). For instance, a machine learning algorithm (MLA), or machine learning model (MLM) trained via a MLA may be for detecting a deviation from a single leg of a journey, or may be for detecting deviations from several legs of a journey that may be represented via the MLA/MLM. For instance, the MLA (or the trained MLM) may comprise a deep learning neural network, or deep neural network (DNN), a generative adversarial network (GAN), a decision tree algorithms/models, such as gradient boosted decision tree (GBDT) (e.g., XGBoost, or the like), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on. Similarly, a regression-based model may be trained and used for prediction, such as linear regression, polynomial regression, ridge regression, lasso regression, etc. In one example, the MLM(s) may be trained at a network-based processing system (e.g., server(s) 125, server(s) 112, or the like).

In one example, an MLM for detecting a deviation from an expected travel sequence may comprise a recurrent neural network (RNN), a long-short term memory (LSTM) neural network, or the like. For instance, RNNs and LSTMs may be trained on and make predictions with respect to time series data. In another example, an MLM for detecting a deviation from an expected travel sequence may comprise a convolutional neural network (CNN) that is suitable for time series data, such as an AlexNet or WaveNet. In accordance with the present disclosure, MLA/MLM inputs may include time stamped location information of user devices (and users), electronic identification tags, transportation service vehicles (e.g., locations of aircraft, trains, baggage carts, etc.). Such time series data may also include sequences of reaching waypoints or beacons (e.g., it is expected that a node or beacon at a check in counter is reached first and at the same time by a luggage item and the associated user and/or user device, followed by the user/user device reaching a node/beacon at a security checkpoint, and similarly a checked luggage item reaching a node/beacon of a baggage cart before or after the user reaching the security checkpoint, and then both the user and the luggage item reaching a node/beacon or node(s)/beacon(s) of a same aircraft). While the exact timing may not have significant weighting via the learning algorithm, the particular ordering of certain events may have a heavy weighting in determining whether a deviation from an expected travel sequence has occurred. Similarly, a separation distance between a luggage item and a user/user device may have varying significance for different legs of a journey. For instance, a checked in luggage item may be permitted to have up to several miles, e.g., two miles, of separation from a user before a deviation is detected. For instance, at some large airports, a check in counter and a departure gate could be several miles apart. However, for a carry-on bag, a separation of even several meters may be significant.

In one example, the present disclosure may apply a MLM in accordance with a “hybrid” MLA approach. For instance, such a “hybrid” approach may be distinguished for other techniques that utilize multiple MLMs such as “ensemble” approaches, bagging, etc. To illustrate, in a “hybrid” MLA approach, multiple MLMs may be used in which the output of one MLM may comprise an input to one or more other MLMs. In one example, each of the MLMs may be considered as a layer or module within an overall MLM. In other words, in such an example, one MLM may be composed of multiple components, which may also be MLMs, and which may be trained separately, or which may be trained collectively. For instance, an output of a neural network-based MLM (e.g., to detect that a luggage item is being dragged/rolled on its wheels, to detect that the luggage item is on a conveyor belt, to detect that the luggage item is on a moving train, etc.) may be an input to a binary classifier for determining whether a deviation from an expected travel sequence has occurred.

In one example, certain factors may be overridden by a user input, e.g., via user device 141 and/or via a button, switch, or other interfaces of the electronic identification tag 151 in the example of FIG. 1. For instance, one aspect of a MLM/MLA may be a separation distance between a luggage item and a user, which may be disabled by a user input via the electronic identification tag 151 (e.g., after entering a passcode) or via an input from a luggage management app on user device 141. This may override actual data to set the separation distance input to the MLM to zero. For instance, user 140 can go to the bathroom or find food and leave the luggage item 150 with a family member or other persons in the same travel party. The MLM may thus detect a deviation from expected conditions when such events occur, but the separation distance may be ignored in this way.

In one example, training data may be gathered from numerous test runs performed by personnel of a provider of a luggage tracking service, a carrier, or the like, by volunteers using provided electronic identification tags, and so forth. For each test run, a label may be applied if a deviation from the expected travel sequence is detected. In one example, the label may be applied to a particular leg of a journey where the deviation occurred. For instance, a separate MLM may be available for each leg of a journey. Upon reaching a milestone or waypoint (e.g., upon checking in a luggage item at a check-in counter, upon boarding an aircraft, upon aircraft landing, etc.), a different MLM may then become active for detecting possible deviations from expected travel sequence for that particular leg.

It should be noted that although FIG. 1 illustrates an example relating to airline travel, other examples may relate to travel by train, ship, bus, etc., which may have corresponding machine learning models (and machine learning algorithms for training such models) for expected travel sequences. Similarly, different types of MLAs/MLMs may be used for different journey legs. For instance, a MLM/MLA for an in-flight travel leg may be fairly simple; e.g., in one example, just detect that duration of flight is within certain limits of expected duration based on itinerary. If the itinerary is not available, a limit may be set based upon maximum long-haul flight, e.g., 12 hours, 18 hours, etc., depending upon current availability. Alternatively, or in addition, the MLM/MLA may be trained to expect a takeoff, cruising, and landing, which can be detected from altimeter data (e.g., a time series of altitude measures).

In one example, MLMs/MLAs may be specific to certain transit locations, e.g., at least 25%, 30%, 40%, etc. of trips used for training data are specific to a particular airport, so that a MLM is trained so as to recognize typical processes with respect to that particular airport. Alternatively, or in addition, MLMs/MLAs may be separately trained to learn expected travel sequences for a checked luggage item versus a carry-on luggage item, etc. with respect to that particular airport (and similarly with respect to other transit locations, such as train stations, bus stations, etc.). As such, in one example, electronic identification tag 151 can have different MLAs/MLMs loaded for different modes of transit within a same trip, based upon an itinerary of user 140. For instance if the departure and arrival airports are known, then MLMs specific to these transit centers may be used. If not, for example user 140 is flying but electronic identification tag 151 is unaware of the destination, electronic identification tag 151 can use a more general MLM, or MLMs, for an in-flight portion and landing/arrival portions. When an itinerary is known to electronic identification tag 151, electronic identification tag 151 may request MLMs from server(s) 125 and/or MLM DB 128 and pre-load such MLMs before the trip is commenced. Switching from one to another MLM can be based upon reaching a milestone or waypoint. For instance, it may be specifically detected that luggage item 150 is loaded on aircraft 160 by sensing node 161, or can be detected by a change in altitude in a short period of time, e.g., a takeoff sequence is detected. Upon such a milestone/waypoint, electronic identification tag 151 may then switch to an in-flight MLM.

When electronic identification tag 151 detects a deviation from an expected travel sequence in accordance with any one or more MLMs operating thereon, the electronic identification tag 151 may generate an alert. In one example, the alert may be presented via a display or speaker of the electronic identification tag 151 and/or of the luggage item 150. Alternatively, or in addition, the alert may be transmitted to user device 141 via peer-to-peer communication and/or via server(s) 125 and over one or more networks. Such an alert may also be shared by electronic identification tag 151, user device 141, and/or server(s) 125 with one or more other authorized stakeholder devices (such as an authorized transportation security provider, an authorized carrier, etc.).

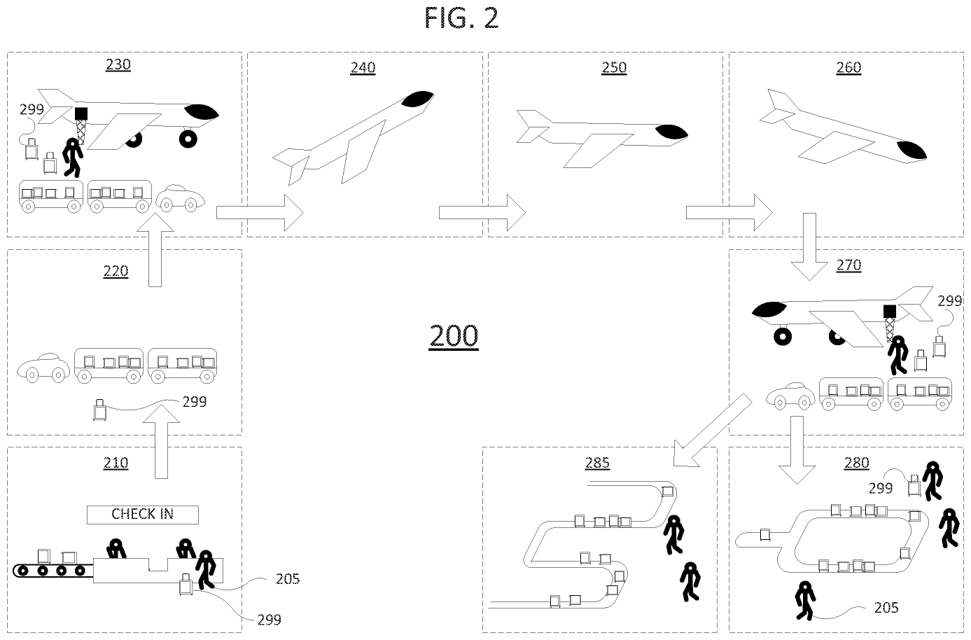

An example of monitoring a journey and detecting a deviation from an expected travel sequence by an electronic identification tag is illustrated in FIG. 2 and described in greater detail below. However, it should be noted that in another example, a network-based luggage monitoring service (e.g., server(s) 125) may similarly gather relevant data (e.g., locations of luggage items and/or electronic identification tags, locations of users and/or user devices, locations of travel service vehicles, itineraries, schedules, etc.), and may apply such data to one or more machine learning models from MLM DB 128 to similarly detect deviations from expected travel sequences. In addition, server(s) 125 may transmit alerts to users and/or user devices associated with luggage items for which deviations are detected, may transmit alerts to the electronic identification tags (e.g., which may display warnings that deviations are detected, may present alarms or verbal instructions, etc.), may transmit alerts to one or more carriers responsible for transporting such luggage items, and so on.

The foregoing illustrates just one example of a system in which examples of the present disclosure for providing an alert in response to detecting a deviation from an expected travel sequence of a luggage item via a machine learning algorithm may operate. In addition, the foregoing is described in connection with just one example travel scenario and transit location. However, it will be appreciated that luggage monitoring for various other travel scenarios through various other transit locations and in connection with various modes of transport or travel may be facilitated via the system 100.

It should also be noted that the system 100 has been simplified. In other words, the system 100 may be implemented in a different form than that illustrated in FIG. 1. For example, the system 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to server(s) 125 may alternatively or additionally be performed by server(s) 112, and vice versa. In addition, although server(s) 112 and 125 are illustrated in the example of FIG. 1, in other, further, and different examples, the same or similar functions may be distributed among multiple other devices and/or systems within the telecommunication network 110, wireless access network(s) 115, and/or the system 100 in general that may collectively provide various services in connection with examples of the present disclosure for providing an alert in response to detecting a deviation from an expected travel sequence of a luggage item via a machine learning algorithm. Additionally, devices that are illustrated and/or described as using one form of communication (such as a cellular or non-cellular wireless communications, wired communications, etc.) may alternatively or additionally utilize one or more other forms of communication. In still another example, there may be various different network-based luggage management services with different servers and other infrastructures. Thus, these and other modifications are all contemplated within the scope of the present disclosure.

FIG. 2 illustrates an example travel sequence 200 in accordance with the present disclosure. For instance, travel sequence 200 may relate to an air travel sequence beginning with an airport check-in stage 210, and ending at a baggage claim stage 280 or 285. In one example, travel sequence 200 may overlap or be similar to the illustrative example(s) discussed above in connection with FIG. 1. In one illustrative example, each stage may have an associated machine learning model (MLM) for detecting/confirming that the stage is in progress or has completed. To illustrate, user 205 may arrive at an airport check in counter and may check-in luggage item 299. In one example, the user 205 may provide a positive indication to an electronic identification tag of the luggage item 299 that the luggage item 299 is being checked-in (for ease of illustration, the electronic identification tag is not specifically labeled in FIG. 2, but in all instances is contained within, affixed or otherwise connected to the luggage item 299). In one example, the user 205 may also have caused a travel itinerary for the entire travel sequence 200 to be pre-loaded onto the electronic identification tag of the luggage item 299. In this regard, associated MLMs may also have been loaded onto the electronic identification tag for use in connection with the travel sequence 200 (e.g., to monitor and alert for deviations from the expected travel sequence). In another example, the electronic identification tag of the luggage item 299 may detect that it is at the check-in counter, e.g., by detecting an RFID node/beacon of the check-in counter.

The check-in process may proceed in a customary manner and may result in loading of luggage item 299 onto a conveyor to be brought to baggage handlers. The luggage item 299 may then be loaded onto a baggage cart (stage 220) to be transported and loaded onto an aircraft (stage 230). While the luggage item 299 is being transported to and loaded on the aircraft via the baggage handling process, user 205 may complete a check-in process and may proceed through a security checkpoint, wait at a departure gate, and may eventually board the aircraft (stage 230). In one example, each of stages 210, 220, and 230 may have a respective MLM to track that the stage is in progress and that there are no deviations from the expected travel sequence (or to alert if a deviation is detected, such as the luggage item 299 appearing to fall off the baggage cart, or to not be loaded onto the baggage cart). In addition, the electronic identification tag of the luggage item 299 may track that the stages 210, 220, and 230 proceed in the proper order (or to alert if the sequence is not correct, e.g., a deviation from the expected travel sequence, such as if it is detected that the luggage item 299 appear to be on a baggage carousel after stage 220, rather than being loading onto the aircraft at stage 230). In one example, the respective MLMs for each stage 210, 220, and 230 may also be specific to the particular departure airport. For instance, different airport may use different type of automated baggage handling systems that process baggage differently, may have different expected climates (e.g., different temperatures) as the baggage cart moves from building to aircraft, may have different terminal layouts that result in greater or lesser separation between users and checked luggage items, and so on.

As noted above, the inputs to the MLMs for each stage may include the locations of the user 205 and luggage item 299, the separation distance between user 205 and luggage item 299, the time of progress for each stage, the completion of each stage relative to a planned departure time according to the itinerary, other sensor data, such as temperature, humidity, audio information, gyroscope and compass data (which may indicate types of movement, such as rocking on a baggage cart, moving on a conveyor belt, etc.), sensing/proximity data regarding beacons/waypoints/nodes, opening/closing sensor data, and so on.

Continuing with the present example, the aircraft may then push back from the gate, taxi to the end of a runway, and takeoff (stage 240) and fly to the destination (stage 250). Similar to the above, the respective MLMs for each of the stages 240 and 250 may also be specific to the particular departure airport. For example, the taxiways and routes to the end of a runway may be learned on an airport-by-airport basis (or per runway, where an airport may have multiple departure runways). In one example, the MLM input factors may also account for the itinerary, including expected departure time, expected arrival time, expected travel duration, or the like. The input factors may also pertain to the type of aircraft scheduled for the flight, for instance, certain aircraft may have distinct engine noise patterns for climbing and cruising, typical cruising speed, angle of attack, etc. Thus, in one example, an input factor to the MLM for stage 250 may comprise a difference between an actual speed detected by the electronic identification tag of luggage item 299 and the typical cruising speed of the aircraft type. In another example, the itinerary, aircraft type, and measured speed and other sensor data may comprise MLM inputs, where the MLM may adapt during a training process to determine the significance of any differences in expected measures based upon the aircraft type with actual measures obtained by the electronic identification tag of the luggage item 299.

At the destination a similar process may unfold in reverse where the aircraft may descend, land, and taxi to an arrival gate (stage 260). At stage 270, luggage item 299 may be removed from the aircraft, loaded onto a baggage cart, and brought to a terminal. Similar to the above, the respective MLMs for each of the stages 260 and 270 may also be specific to the particular arrival airport (and the inputs may account for the type of aircraft, the itinerary, and so on). The travel sequence 200 may culminate in the user 205 retrieving luggage item 299 from a baggage claim area, which may have an associated MLM for the baggage claim phase (stage 280). However, in the illustrative example of FIG. 2, it may be the case that another person has mistakenly removed luggage item 299 from a baggage carousel and started to walk away. In this case, the electronic identification tag of luggage item 299 may detect an unexpected movement of the luggage item 299. For instance, the trained MLM may expect that motion sensors continue to indicate that the luggage item 299 remains on a baggage carousel until removed by the user 205, which may be detected when the electronic identification tag determines that user device is next to the luggage item (e.g., within several meters, e.g., no more than three to five meters away). In other words, the sequence of the luggage item 299 being lifted and rolled or carried without the immediate proximity of user 205 is strongly indicative of a deviation from the expected travel sequence, and may result in the output of the MLM exceeding a threshold and triggering an alert. The alert may be presented via a display or speaker of the electronic identification tag and/or of the luggage item 299. Alternatively, or in addition, the alert may be transmitted to a device of user 205, a network-based luggage monitoring system, one or more other authorized stakeholder devices, and so on.

Although the travel sequence 200 may end at stage 280, to further illustrate aspects of the present disclosure, an alternative stage 285 is also illustrated in FIG. 2. In particular, stage 285 may be similar to stage 280, but may relate to a different destination airport, and may use a different machine learning model for detecting deviations from the expected travel sequence. For example, a second airport may use an S-shaped conveyor, or snaking conveyor at a baggage claim, instead of an oval or racetrack shape that may be used at other airports (such as illustrated in stage 280). Thus, different machine learning models may be trained on different input data from prior transits of the respective airport baggage claims to learn what is expected or customary at one airport versus another, which may include the expectation that sensor data indicates the luggage item 299 is on an oval/racetrack conveyor (airport 1, stage 280) or on a snaking conveyor (airport 2, stage 285). It should also be noted that the travel sequence 200 is illustrative in nature and just one example of how a travel sequence may proceed in stages, and how different MLMs may apply to these different stages. For instance, in another example, stage 240 may be separated into two or more stages, e.g., a pushback and taxi stage, and takeoff stage, a climb stage, etc. Similarly, stage 260 may be separated into a descent stage, a landing stage, a touchdown and braking stage, a taxiing stage, etc., each with concomitant machine learning model to detect that the stage is proceeding as expected (or that a deviation has occurred). In addition, various types of deviations may be detected using various machine learning models, such as model for detecting rough handling, a model for predicting whether the conveyance of luggage item 299 resulted in damage to the luggage item 299 and/or its contents, and so forth. Thus, these and other modifications are all contemplated within the scope of the present disclosure.

FIG. 4 illustrates a flowchart of an example method 400 for providing an alert in response to detecting a deviation from an expected travel sequence of a luggage item via a machine learning algorithm. In one example, steps, functions and/or operations of the method 400 may be performed by an electronic identification tag of a luggage item (e.g., electronic identification tag 151 of FIG. 1), or any one or more components thereof (e.g., various sensors such as a GPS unit, a microphone, an altimeter, etc.), or by electronic identification tag 151 and/or any one or more components thereof in conjunction with one or more other components of luggage item 150 (e.g., an opening sensor, a microphone, etc.) or other components of the system 100, such as server(s) 125, server(s) 112, nodes 161, 171, and 181, elements of wireless access network 115, telecommunication network 110, and so forth.

In one example, the steps, functions, or operations of method 400 may be performed by a computing device or processing system, such as computing system 500 and/or hardware processor element 502 as described in connection with FIG. 5 below. For instance, the computing system 500 may represent any one or more components of the system 100 (e.g., electronic identification tag 151) that is/are configured to perform the steps, functions and/or operations of the method 400. Similarly, in one example, the steps, functions, or operations of the method 400 may be performed by a processing system comprising one or more computing devices collectively configured to perform various steps, functions, and/or operations of the method 400. For instance, multiple instances of the computing system 500 may collectively function as a processing system. For illustrative purposes, the method 400 is described in greater detail below in connection with an example performed by a processing system. The method 400 begins in step 405 and proceeds to step 410.

At step 410, the processing system (e.g., of a luggage item, such as of an electronic identification tag embedded or contained in the luggage item, or otherwise affixed to the luggage item) obtains at least one input indicating an expected travel sequence associated with the luggage item. For instance, the at least one input comprises a selection of a travel mode, such as a checked bag mode, a carry-on bag mode, a gate check mode, and so forth. In one example, the checked bag mode may further be refined e.g., a checked bag with one layover mode, a check bag with two layovers mode, a checked bag with no layover mode, etc. It should be noted that these travel modes are merely illustrative in nature, and that other travel modes may be available for selection in accordance with the present disclosure, and may be specific to different transit modalities, e.g., air travel, cruising, train travel, bus travel, etc. The at least one input may alternatively or additionally comprise a trip itinerary, or travel itinerary of the user. For instance, the travel itinerary may include an identification of a carrier, a flight number, a departure airport, a destination airport, an expected departure time, an expected arrival time, and so forth. The trip itinerary may further include an indication of whether the luggage item is a checked baggage item or a carry-on baggage item. In one example, the user may load the trip itinerary to the processing system, e.g., via a luggage management app on a user device.

At optional step 420, the processing system may obtain at least one machine learning model for detecting a deviation from the expected travel sequence associated with the luggage item. For instance, the at least one machine learning model may be loaded from a network-based system that may store machine learning models associated with different expected different travel legs, different transit modalities, different transit centers (e.g., different airport, different train stations, etc.), and so on. The different machine learning models may have been trained based upon past travel sequences of various users engaging in different modes of travel via the different transit centers. For instance, the at least one machine learning model is trained with a training data set that is specific to a mode of transportation, such as a ground surface motor vehicle mode of transportation, a waterborne mode of transportation, an airplane mode of transportation, a helicopter mode of transportation, a train mode of transportation, etc. In one example, the training data set comprises luggage sensor inputs and user location information associated with a plurality of trips of a plurality of users.

It should be noted that in one example, the training data set may further comprise luggage sensor inputs and user location information associated with a plurality of trips of the user. For instance, the processing system, a user device, or both may provide sensor data and user location information from multiple user trips which may be used to train the one or more machine learning models. In one example, these user-specific training examples may be combined with training examples of other users, but may be weighted more heavily (since the user is the best example of the user's own expected travel habits). The weighting may comprise a tunable parameter of the one or more MLMs, for instance. Similarly, the plurality of trips of the plurality of users may comprise a threshold percentage of trips that are specific to a particular transit location. For instance, for a MLM that is specific to a particular airport, a tunable parameter of the MLM training may be that at least 25%, 30%, 40%, etc. of trips are specific to a particular airport, so that the MLM is trained so as to recognize normal processes with respect to that airport. Examples from other airports may still be used for training, but minimum percentage of training examples specific to the particular transit location may help ensure that the MLM training is sufficiently adapted to the particular transit location. In one example, as more users and more luggage items (or electronic identification tags thereof) participate, the minimum percentage of training examples specific to a particular transit location may be increased.

It should be noted that the processing system may obtain different MLMs for different modes of transit within a same trip, based upon the itinerary. For instance, if a user is taking a taxi to the airport, is flying to a destination, will take a bus to a cruise terminal, and will board a cruise ship, various MLMs may be obtained for each of these different modes of transit (and for different legs within each mode of transit, such as the example travel sequence 200 of FIG. 2). In addition, if the departure and arrival airports, train stations, etc. are known, then MLMs specific to those transit center may be used. If not, for example the user is flying but the processing system of the luggage item is unaware of the destination, it can use a more general MLM for an in-flight portion and landing/arrival portion of the expected travel sequence. In a similar manner, the at least one MLM may also be incrementally retrained as the user takes more and more trips. For instance, the user may frequently fly from the user's home airport and thus, MLMs relating to check-in, baggage handling, pushback to takeoff, etc. may be transit center specific, but may also be adapted to the user's particular habits as well. In one example, the at least one machine learning model may include a deep neural network, such as a recurrent neural network, a long short term memory network, or a convolutional neural network for time series data (e.g., an AlexNet or a WaveNet which extend more general convolutional neural networks with enhanced performance with respect to time series data).

At step 430, the processing system obtains a set of sensor inputs for the luggage item. For instance, the luggage item may be started on the expected travel sequence and may collect sensor inputs that may be used to verify the luggage item is on the expected travel sequence (or has deviated therefrom). In one example, the luggage item may be started on the expected travel sequence via an input from the user, e.g., such as via a keypad, button, or other interface of the luggage item (and/or an electronic identification tag associated with the luggage item), via an application on a device of the user, or the like. The sensor inputs may include an altitude of the luggage item, a location of the luggage item, an acceleration of the luggage item, an orientation of the luggage item, a temperature of the luggage item, audio information of the luggage item, and so on. For instance, the set of sensor inputs may be obtained from one or more sensors, including: an altimeter, a GPS unit, an accelerometer, a gyroscope, a compass, a thermometer, a radiation sensor (e.g., an x-ray sensor), a microphone (acoustic sensor), and so on. The set of sensor inputs may also include scanning information relating to the processing system sensing and/or communicating with one or more nodes/beacons (e.g., waypoints) during the movement of the luggage item. In this regard, the sensor inputs may be obtained from sensors of the luggage item (or an electronic identification tag thereof) or from one or more external sensors which may subsequently communicate with the processing system, or from which the processing system may obtain the respective sensor data.

At step 440, the processing system obtains location information of a user associated with the luggage item. The location information may be of a user device, such as peer-to-peer wireless communication with the processing system via one of the modalities described above, or the like (e.g., Bluetooth, Wi-Fi Direct, LTE Direct, DSRC, 5G D2D, etc.), or could be that the user checks in at a gate, such as scanning a boarding pass, or is verified to be at some location in a similar manner that does not specifically involve knowing the location of the user's device(s). Alternatively, or in addition, the user location may be obtained from a network-based system (e.g., a luggage management system) that is in communication with the processing system of the luggage item, a user device, and/or one or more third-party devices or systems (e.g., an airport network) which may provide information regarding scans of luggage items and/or electronic identification tags thereof by nodes/waypoints, detection of user locations, flight delays or changes which may affect the expected travel sequence, and so on.

At step 450, the processing system applies the set of sensor inputs and the location of the user to at least one machine learning model of the processing system, wherein the at least one machine learning model is to detect a deviation from the expected travel sequence. As noted above, the at least one MLM may be specific to a particular portion of the expected travel sequence. Thus for example, a MLM may expect that for pushback and takeoff, the luggage item and the user may have a same separation distance, but should move in parallel, and that the speeds should be the same. In addition, the MLM may expect a certain duration of time at lower speeds suitable for taxiing, followed by a rapid acceleration, followed by increased speed and/or acceleration along with a steep increase in altitude. These aspects may be characterized by the sensor inputs and the location information of the user obtained at steps 430 and 440. In one example, steps 430-450 may be performed on an ongoing basis (e.g., to collect additional sensor inputs and user location information which may be further processed by the at least one machine learning model).

At step 460, the processing system determines, via an output of the machine learning model, that a deviation from the expected travel sequence has occurred. For instance, the deviation may be determined when an output, e.g., a score, of the machine learning model, exceeds a threshold. For instance, if outputs range from 0 to 100, the threshold may be 60, 70, 80, etc. In one example, the threshold may be user-configurable. For instance, one user may prefer to be highly informed and will tolerate some false positives, while another user may only wish to be alerted when there is very high confidence that a deviation has occurred. It should again be noted that different machine learning models may be applied to different legs of an expected travel sequence. For instance, an MLM for an in-flight leg may be fairly simple, e.g., in one example it may detect that a duration of flight is within certain limits of expected duration based on an itinerary. If not, a limit may be set based upon a maximum long-haul flight, e.g., 18 hours. For instance, takeoff and landing may be detected from an altimeter, which may start and stop the tracking of the flight duration. Although other sensor data may be available, it may be unnecessary as inputs for at least one example MLM. However, for other legs, a deep neural network-based MLM may be utilized.

At optional step 470, the processing system may determine a mode of transportation, in response to determining the deviation from the expected travel sequence. For instance, the luggage item may be expected to be loaded onto an aircraft and in flight at a particular time according to the expected travel sequence (e.g., in accordance with the travel itinerary). However, the processing system may detect a deviation (e.g., that the luggage item is not in-flight when expected). Although the at least one MLM may be specific to the in-flight portion, one or more additional MLMs may be operating in parallel and/or may be activated in response to the detection of the deviation, where the one or more additional MLMs may be to detect a ground surface motor vehicle mode of transportation, a waterborne mode of transportation, an airplane mode of transportation, a helicopter mode of transportation, a train mode of transportation, etc. In one example, the processing system may possess base MLMs for this purpose (that are not necessarily specific to any particular transit centers, vehicle types, the user, etc.). Alternatively, or in addition, the mode of transportation may be determined by sensing/scanning a node/beacon that is indicative of the mode of transportation (e.g., a node of aircraft, a node of a train, a node of a taxi, etc.).

At step 480, the processing system provides an alert via at least one of an output component of the luggage item, e.g., a display and/or speaker of the luggage item and/or an electronic identification tag thereof, or a computing device of the user. In the latter case, the computing device of the user may be provided the alert via peer-to-peer communications (e.g., Bluetooth, Wi-Fi Direct, LTE Direct, DSRC, 5G D2D, etc.) or via a network-based system (e.g., a luggage management system). In one example, the alert may also be shared with one or more other authorized stakeholder devices (such as an authorized transportation security provider, an authorized carrier, etc.). In one example, the alert may comprise the mode of transportation that is determined at optional step 470. For instance, if the detected mode of transportation is ground surface motor vehicle mode of transportation and the user is waiting for the luggage item at an airport baggage claim, providing this information along with the alert may indicate that someone has just recently mistakenly taken the user's luggage item (or has intentionally stolen the luggage item).

Following step 480, the method 400 may proceed to step 495. At step 495, the method 400 ends.

It should be noted that the method 400 may be expanded to include additional steps, or may be modified to replace steps with different steps, to combine steps, to omit steps, to perform steps in a different order, and so forth. For instance, in one example the processing system may repeat one or more steps of the method 400, such as steps 410-450 or steps 410-480 for additional trips. In one example, the method 400 may further include obtaining a user input dismissing the alert. For instance, the user may be traveling with a companion and may leave the luggage item in the possession of the companion. If the user moves sufficiently far away, e.g., to another part of an airport terminal looking for food, this may result in the at least one MLM alerting of a deviation. However, since the user is unconcerned (having intentionally left the proximity to the luggage item) the user may dismiss the alert. Similarly, in another example, certain MLM input features may be disabled via user input via the luggage item (and/or the electronic identification tag thereof) or via an app on a device of the user. For instance, the separation distance between luggage item and user can be disabled. This may override actual sensor data and user location data of steps 430 and 440 to set the separation distance input to the MLM at step 450 to zero. For instance, user can go to the bathroom or find food and leave the luggage item with a family member or other persons in the same travel party. The MLM may thus detect a deviation from expected conditions when such events occur, but the separation distance may be ignored in this way. In one example, the method 400 may include obtaining an override input prior to an iteration of steps 430 and 440. In one example, the method 400 may further include obtaining notification of an itinerary change (e.g., during the journey) and altering the expected travel sequence to account for the itinerary change. For instance, if the itinerary change is a change in destination airport, the processing system may obtain one or more different MLMs that may account for the new destination airport. Alternatively, or in addition, the itinerary change may result in the change of one or more input factors of one or more MLMs, for instance, the expected flight duration may change based upon the new itinerary, and so on.

In still another example, the method 400 may include detecting a current leg of the expected travel sequence, and selecting a MLM or MLMs to apply accordingly. For instance, detecting the start of a leg of a journey and/or switching from one to another MLM can be based upon reaching a milestone or waypoint. For instance, it may be specifically detected that the luggage item is loaded on an airplane via NFC sensing or communication with a node/beacon on board the airplane, e.g., on the loading ramp, or can be detected by certain expected conditions in accordance with a MLM for a prior leg of the journey (e.g., a rapid change in altitude in a short period of time indicates that takeoff is proceeding as expected, but may also indicate that switching to an in-flight/cruising MLM should occur).

In yet another example, aspects of the method 400 may alternatively be performed by a network-based processing system (e.g., a luggage management system, such as server(s) 125 and/or server(s) 112 of FIG. 1). For instance, the luggage management system may obtain information indicating an expected travel sequence associated with the luggage item, may activate one or more appropriate MLMs, may obtain sensor inputs from the luggage item (e.g., from the electronic identification tag thereof), may obtain user location information from a user device and/or from third-party sources (and may also obtain additional information regarding the luggage item, such as information regarding scans of the luggage item by various nodes/beacons within a transportation system), may apply these as inputs to the one or more machine learning models to detect a deviation from the expected travel sequence, and may provide alerts to the luggage item, the user device, and/or other entities, and so forth. For instance, the luggage management system may maintain communications via one or multiple networks with the user device, the electronic identification tag of the luggage item, or both, for all or various portions of an overall journey, or travel sequence. Thus, these and other modifications are all contemplated within the scope of the present disclosure.

In addition, although not expressly specified above, one or more steps of the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 4 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 5 depicts a high-level block diagram of a computing system 500 (e.g., a computing device or processing system) specifically programmed to perform the functions described herein. For example, any one or more components, devices, and/or systems illustrated in FIG. 1 or described in connection with FIGS. 1-4, may be implemented as the computing system 500. As depicted in FIG. 5, the computing system 500 comprises a hardware processor element 502 (e.g., comprising one or more hardware processors, which may include one or more microprocessor(s), one or more central processing units (CPUs), and/or the like, where the hardware processor element 502 may also represent one example of a “processing system” as referred to herein), a memory 504, (e.g., random access memory (RAM), read only memory (ROM), a disk drive, an optical drive, a magnetic drive, and/or a Universal Serial Bus (USB) drive), a module 505 for providing an alert in response to detecting a deviation from an expected travel sequence of a luggage item via a machine learning algorithm, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 502 is shown, the computing system 500 may employ a plurality of hardware processor elements. Furthermore, although only one computing device is shown in FIG. 5, if the method(s) as discussed above is implemented in a distributed or parallel manner for a particular illustrative example, e.g., the steps of the above method(s) or the entire method(s) are implemented across multiple or parallel computing devices, then the computing system 500 of FIG. 5 may represent each of those multiple or parallel computing devices. Furthermore, one or more hardware processor elements (e.g., hardware processor element 502) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 502 can also be configured or programmed to cause other devices to perform one or more operations as discussed above. In other words, the hardware processor element 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 505 for providing an alert in response to detecting a deviation from an expected travel sequence of a luggage item via a machine learning algorithm (e.g., a software program comprising computer-executable instructions) can be loaded into memory 504 and executed by hardware processor element 502 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 502) executing the computer-readable instructions relating to the above described method(s) can be perceived as a programmed processor or a specialized processor. As such, the present module 505 for providing an alert in response to detecting a deviation from an expected travel sequence of a luggage item via a machine learning algorithm (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system of a luggage item, the processing system including at least one processor, at least one input indicating an expected travel sequence associated with the luggage item;
obtaining, by the processing system, a set of sensor inputs for the luggage item;
obtaining, by the processing system, location information of a user associated with the luggage item;
applying, by the processing system, the set of sensor inputs and the location information of the user to at least one machine learning model, wherein the at least one machine learning model is to detect a deviation from the expected travel sequence;
determining, by the processing system via an output of the at least one machine learning model, that a deviation from the expected travel sequence has occurred; and
providing, by the processing system, an alert via at least one of an output component of the luggage item or a computing device of the user.

2. The method of claim 1, wherein the at least one input further comprises a selection of a travel mode.

3. The method of claim 2, wherein the travel mode comprises one of:
a checked bag mode;
a carry-on bag mode; or
a gate check mode.

4. The method of claim 3, wherein the checked bag mode comprises:
a checked bag with one layover mode;
a checked bag with two or more layovers mode; or
a checked bag with no layovers mode.

5. The method of claim 1, wherein the at least one input comprises a travel itinerary of the user.

6. The method of claim 1, wherein the set of sensor inputs comprises at least one of:
an altitude of the luggage item;
a location of the luggage item;
an acceleration of the luggage item;
an orientation of the luggage item;
a temperature of the luggage item; or
audio information of the luggage item.

7. The method of claim 1, wherein the set of sensor inputs is obtained from at least one sensor, the at least one sensor comprising at least one of:
an altimeter;
a global positioning system unit;
an accelerometer;
a gyroscope;
a compass;
a thermometer;
a radiation sensor; or
a microphone.

8. The method of claim 1, wherein the at least one machine learning model is trained with a training data set that is specific to a mode of transportation.

9. The method of claim 8, wherein the mode of transportation comprises:
a ground surface motor vehicle mode of transportation;
a waterborne mode of transportation;
an airplane mode of transportation;
a helicopter mode of transportation; or
a train mode of transportation.

10. The method of claim 8, wherein the training data set comprises luggage sensor inputs and user location information associated with a plurality of trips of a plurality of users.

11. The method of claim 10, wherein the training data set further comprises luggage sensor inputs and user location information associated with a plurality of trips of the user.

12. The method of claim 10, wherein the plurality of trips of the plurality of users comprises a threshold percentage of trips that are specific to a particular transit location.

13. The method of claim 1, further comprising:
determining a mode of transportation, in response to the determining the deviation from the expected travel sequence.

14. The method of claim 13, wherein the alert comprises the mode of transportation that is determined.

15. The method of claim, 1 wherein the at least one machine learning model comprises a deep neural network.

16. The method of claim 1, further comprising:
obtaining, by the processing system, the at least one machine learning model from a network-based system.

17. A non-transitory computer-readable medium storing instructions which, when executed by a processing system of a luggage item including at least one processor, cause the processing system to perform operations, the operations comprising:
obtaining at least one input indicating an expected travel sequence associated with the luggage item;
obtaining a set of sensor inputs for the luggage item;
obtaining location information of a user associated with the luggage item;
applying the set of sensor inputs and the location information of the user to at least one machine learning model, wherein the at least one machine learning model is to detect a deviation from the expected travel sequence;
determining, via an output of the at least one machine learning model, that a deviation from the expected travel sequence has occurred; and
providing an alert via at least one of an output component of the luggage item or a computing device of the user.

18. The non-transitory computer-readable medium of claim 17, wherein the at least one input further comprises a selection of a travel mode.

19. The non-transitory computer-readable medium of claim 18, wherein the travel mode comprises one of:
a checked bag mode;
a carry-on bag mode; or
a gate check mode.

20. An apparatus comprising:
a processing system including at least one processor; and
a computer-readable medium storing instructions which, when executed by the processing system, cause the processing system to perform operations, the operations comprising:
obtaining at least one input indicating an expected travel sequence associated with a luggage item;
obtaining a set of sensor inputs for the luggage item;
obtaining location information of a user associated with the luggage item;
applying the set of sensor inputs and the location information of the user to at least one machine learning model, wherein the at least one machine learning model is to detect a deviation from the expected travel sequence;
determining, via an output of the at least one machine learning model, that a deviation from the expected travel sequence has occurred; and
providing an alert via at least one of an output component of the luggage item or a computing device of the user.
